(19) United States
(12) Patent Application Publication
(10) Pub. No.: US 2008/0309621 A1
(43) Pub. Date: Dec. 18, 2008

(54) PROXIMITY BASED STYLUS AND DISPLAY SCREEN, AND DEVICE INCORPORATING SAME

(76) Inventors: Akhil AGGARWAL, Durham, NC (US); Johnny Moore, Raleigh, NC (US); Noah B. Ash, Raleigh, NC (US); John Eric Ang, Raleigh, NC (US); Jean Chu, Raleigh, NC (US); Gary R. Tolsma, Raleigh, NC (US)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 11/763,579

(22) Filed: Jun. 15, 2007

(51) Int. Cl. G06F 3/041

(52) U.S. Cl. 345/173; 345/179

(57) ABSTRACT

An electronic device includes a display for displaying icons selectable with use of a stylus, a stylus location determination function that determines a location of the stylus in relation to the display without necessitating that the stylus make physical contact with the display, and a highlight function, operatively coupled to the stylus location determination function, that highlights the icon associated with the location of the stylus prior to the stylus making physical contact with the display.

### TECHNICAL FIELD OF THE INVENTION

The present invention relates generally to electronic devices, and more particularly to electronic devices incorporating a stylus and touch-sensitive display with which a user may input information, control functionality, etc.

### DESCRIPTION OF THE RELATED ART

Various types of electronic devices, such as portable electronic devices, have been popular for decades and continue to increase in popularity. In the communications area, advances in electronic equipment such as digital telephones, mobile phones, pagers, communicators, electronic organizers, personal digital assistants (PDAs), smartphones, etc. have made it possible for seemingly everyone to own one or more different devices.

Electronic devices, and particularly portable electronic devices, frequently include a display having a touch-sensitive screen. The electronic devices oftentimes include a stylus with which the user may select icons, enter information, etc. via the touch-sensitive screen. Because the devices are portable, however, the display screen can be relatively small. Even with the use of the stylus, this can make the selection of icons, entry of information, etc., difficult for the user via the touch-sensitive display. The user may have trouble seeing exactly where the tip of the stylus is relative to the touch-sensitive screen. This can result in entry of erroneous data, selection of an unintended icon, or the like. Moreover, this can lead to user frustration and resultant dissatisfaction with the electronic device as a whole.

In view of the aforementioned shortcomings associated with existing devices, there is a strong need in the art for a touch-sensitive display and stylus that better enables a user to utilize the display without erroneous data entry, unintended selection, frustration, etc.

### SUMMARY

According to an aspect of the invention, an electronic device is provided that includes a display for displaying icons selectable with use of a stylus, a stylus location determination function that determines a location of the stylus in relation to the display without necessitating that the stylus make physical contact with the display, and a highlight function, operatively coupled to the stylus location determination function, that highlights the icon associated with the location of the stylus prior to the stylus making physical contact with the display.

According to another aspect, the display is a touch sensitive display screen.

In accordance with another aspect, the highlight function magnifies the icon being highlighted.

According to still another aspect, the highlight function comprises a cursor presented on the display directed to the icon being highlighted.

According to yet another aspect, the highlight function alters a visual characteristic of the icon being highlighted.

In accordance with another aspect, the stylus location determination function includes an array of inductive sensors for sensing changes in a magnetic field resulting from the stylus.

According to another aspect, the electronic device the stylus comprises a tip including ferromagnetic material.

In accordance with another aspect, the stylus location determination function includes an array of optical sensors for sensing optical radiation emitted by the stylus.

According to another aspect, the stylus includes an optical radiation light source.

According to still another aspect, the electronic device includes an input for receiving information from the stylus indicative of the position of the stylus relative to the display, and the stylus location determination function determines which icon displayed on the display is associated with the location of the stylus prior based on the received information.

In accordance with another aspect, the information received from the stylus is based on at least one of an accelerometer or global positioning system included within the stylus.

According to another aspect, the information received from the stylus is based on an optical device included in the stylus for detecting a path traveled by a light beam along the surface of the display.

According to still another aspect, the stylus includes circuitry for providing audible and/or tactile feedback to a user when the stylus contacts the surface of the display.

In accordance with another aspect of the invention, an electronic device is provided that includes a display, a stylus location determination function that determines a location of a stylus relative to the display as the stylus moves across the display, without the stylus necessarily making physical contact with the display, and a highlight function, operatively coupled to the stylus location determination function, that highlights on the display the movement of the stylus determined by the stylus location determination function.

According to another aspect, the display is a touch sensitive display screen.

In accordance with still another aspect, the stylus location determination function determines the movement of the stylus subsequent to the stylus touching the touch sensitive display, and the highlight function highlights on the display the movement of the stylus relative to the point at which the stylus touched the touch sensitive display.

According to yet another aspect, the highlight function highlights the movement by creating a rectangle on the display that includes in one corner the point at which the stylus touched the display, and includes in an opposite corner the current location of the stylus relative to the display.

With still another aspect, the stylus location determination function comprises an array of at least one of inductive sensors for sensing changes in a magnetic field resulting from the stylus, or optical sensors for sensing optical radiation emitted by the stylus.

According to another aspect, the electronic device includes an input for receiving information from the stylus indicative of the position of the stylus relative to the display, and the stylus location determination function determines the movement of the stylus based on the received information.

In accordance with another aspect, the information received from the stylus is based on at least one of an accelerometer, global positioning system or optical device included within the stylus.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

FIG. 1 is a perspective view of an electronic device including a display and stylus in accordance with an exemplary embodiment of the present invention;

FIGS. 2, 3, 4 and 5 are each a partial view of the display of FIG. 1 in accordance with different examples of the present invention;

FIG. 6 is a partial view a display shown in partial cutaway in accordance with an embodiment of the present invention;

FIG. 7 is a block diagram representing display drivers and sensor drivers included in a display in accordance with and embodiment of the present invention;

FIG. 8 is a schematic end view of the display in accordance with an embodiment of the present invention;

FIG. 9 is a partial plan view of a stylus in accordance with an embodiment of the present invention;

FIG. 10 is a partial plan view of a stylus in accordance with another embodiment of the present invention;

FIG. 11 is a block diagram of the stylus of FIG. 10;

FIG. 12 is a functional block diagram of the electronic device of FIG. 1 in accordance with an exemplary embodiment of the present invention;

FIG. 13 is a block diagram of a stylus in accordance with still another embodiment of the present invention;

FIG. 14 is a block diagram of a stylus in accordance with yet another embodiment of the present invention;

FIG. 15 is a partial view of the display of FIG. 1 in accordance with another embodiment of the present invention; and

FIG. 16 is a block diagram of a stylus in accordance with still another embodiment of the present invention.

### DETAILED DESCRIPTION OF EMBODIMENTS

The present invention will now be described with reference to the drawings, in which like reference labels are used to refer to like elements throughout.

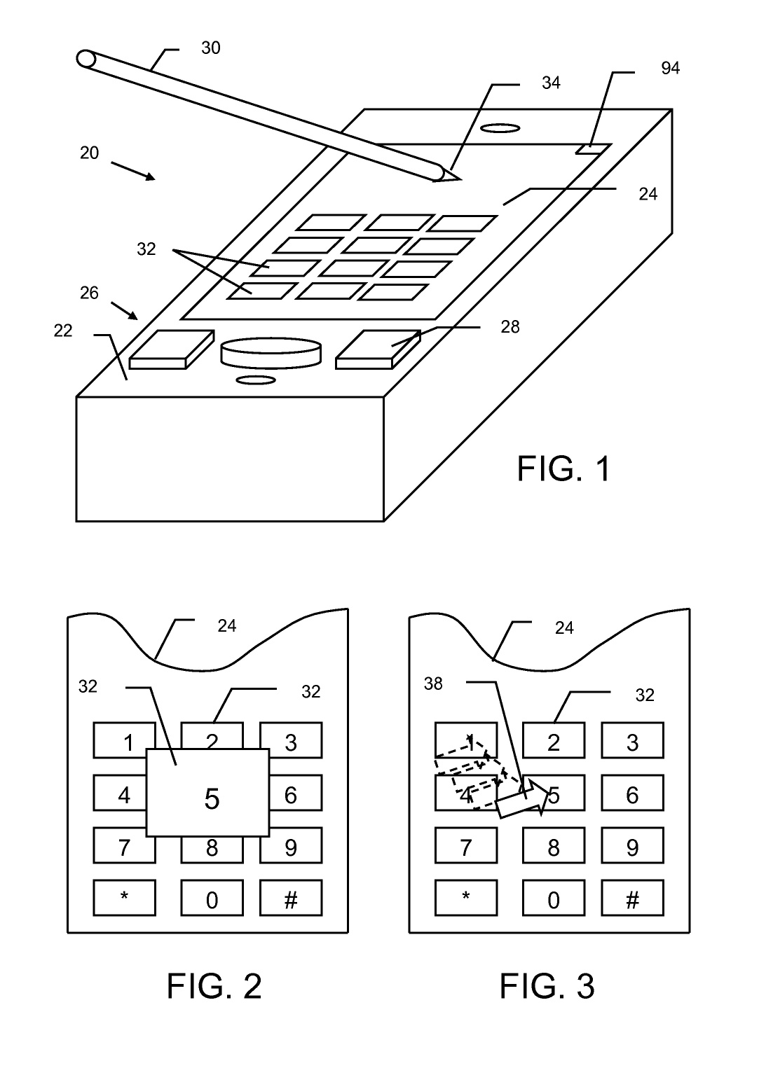

Referring initially to FIG. 1, an electronic device 20 is shown in accordance with an exemplary embodiment of the present invention. In the exemplary embodiment, the electronic device 20 is a mobile phone. However, it will be appreciated that the electronic device 20 may be any other type of electronic device including, for example, other portable electronic devices such as personal digital assistants (PDAs), electronic organizers, media players, etc.

The electronic device 20 includes a housing 22 in which the various electronic components making up the device 20 are housed. Included on a face of the housing 22 is a display 24 and a keypad 26 including a variety of keys (e.g., 28). According to the exemplary embodiment, the display 24 is a touch sensitive display. Using conventional techniques, the display 24 includes a screen that is sensitive to touch via a stylus 30 or other object serving as a stylus (e.g., paperclip, fingernail, etc.). The display 24 displays one or more icons 32 which may be selected using the stylus 30. As referred to herein, the icons 32 may represent any type of figure or image presented on the display that are designed to be selectable via the stylus.

The electronic device 20 detects which icon 32 is selected by the user by determining where on the touch sensitive screen the stylus or other object serving as a stylus touches the display 24. The icon 32 corresponding to the location at which the touch sensitive screen is touched is thereby considered selected. The electronic circuitry within the device 20 in turn responds to the input by the user by carrying out an appropriate function or functions as is conventional.

As discussed above in relation to conventional devices, the touch sensitive display 24 may be problematic in the case of a small display and/or small icons 32 displayed on the display 24. A user may have difficulty seeing which icon 32 is being selected due to the user's fingers or the stylus 30 obstructing the user's view. Conventionally, the user does not know for sure which particular icon 32 has been selected until after the stylus 30 has contacted the display 24 and the device 20 has responded accordingly.

The electronic device 20 of the present invention overcomes such limitations by including what is referred to herein as “proximity-based” stylus operation. As will be described in more detail below, the electronic device 20 includes circuitry that enables the position of the stylus 30, and specifically the tip 34, to be ascertained relative to the display 24 without necessitating that the stylus 30 actually contact the touch sensitive display 24. By detecting the position of the stylus 30 (i.e., as projected downward onto the surface of the display 24) prior to the stylus actually touching the touch sensitive display 24 and thereby selecting a corresponding icon 32, the electronic device 20 is able to highlight on the display 24 the particular icon 32 associated with the location of the stylus 30. By highlighting the particular icon 32, the electronic device 20 provides the user with visual feedback with respect to which icon 32 the user is likely to select should the user proceed with touching the stylus 30 down onto the display 24.

In general, when inputting information the user will move the position of the tip of the stylus 30 across the surface of the display 24 without necessarily touching the surface of the display 24 so as to select an icon 32. The electronic device 20 determines the location of the tip 34 of the stylus 30 as it is moved while suspended above the surface of the display 24. The electronic device 20 uses such location information to visually highlight the particular icon 32, if any, associated with such location on the display 24.

As the user moves the stylus 30 above the surface of the display 24, the electronic device 20 continues to ascertain the location of the stylus 30. As a result, the electronic device 20 continuously updates which icons 32 are highlighted on the display 24 even while the user moves the stylus 30 above the surface of the display 24. When the user wishes to specifically select an icon 32, the user simply proceeds to move the stylus 30 downward towards the surface of the display 24, thereby contacting the display 24. The icon 32 is thereafter selected and processed in accordance with conventional touch sensitive display techniques.

As explained in more detail below, the location of the stylus 30 may be determined using a variety of different techniques. For example, the electronic device 20 may determine the location of the stylus 30 based on an array of inductive sensors positioned beneath the surface of the display 24. The inductive sensors detect changes in a magnetic field resulting from the presence of the stylus 30.

Alternatively, the electronic device 20 may include an array of light sensors arranged beneath the surface of the display 24 and configured to detect a light beam projected from the tip 34 of the stylus 30. As yet another alternative, the stylus 30 may itself include a movement sensor for sensing movement of the stylus 30 relative to the display 24. The stylus 30 provides information relating to such movement to the electronic device 20 in order that an icon 32 associated with the location of the stylus 30 may be highlighted. The movement sensor may include an accelerometer, global positioning system (GPS), laser-based optics, etc., as will be explained in more detail below.

In addition to facilitating the selection of icons 32 on the display 24, the present invention also is useful in highlighting movement of the stylus 30 across the display 24 without requiring that the stylus actually contact the display 24. Accordingly, a user may highlight a portion of the display 24 as part of a cut-and-paste operation or drag-and-drop operation, for example, without touching the display 24 with the stylus 30 as will be described in more detail below. Similarly, the invention may serve to highlight the path of the stylus 30 as the user moves the stylus 30 across the display 24 without touching the display. Such operation may be useful in entering manuscript, making graphical edits, etc. Since it is not necessary for the stylus 30 to touch the display 24, it will be appreciated that it is not necessary that the display 24 be a touch sensitive display in order to benefit from the invention.

Referring to FIGS. 2-5, various examples are shown for highlighting icons 32 based on the determined location of the stylus 30. In FIG. 2, the electronic device 20 determines that the location of the stylus 30 (not shown) in relation to the display 24 is directly above (although not necessarily touching) the icon representing the numeric key “5”. In turn, the electronic device 20 causes the relative size of the numeric key “5” icon to expand or “explode” on the display 24. Thus, the user is better able to see which particular icon 32 (e.g., the numeric key “5”) the user will select by then bringing the stylus tip 34 down into contact with the surface of the display 24. Moreover, since the size of the icon 32 (e.g., the numeric key “5”) is increased, the electronic device 20 may correspondingly increase the footprint on the touch sensitive screen in relation to the numeric key “5”. As a result, the user has a larger area on the surface of the display 24 with which to select the icon 32 by contact via the stylus 30.

FIG. 3 illustrates an example in which the electronic device 20 highlights the icon 32 corresponding to the determined location of the stylus 30 by displaying a cursor 38 (e.g., arrow) which points to the icon. As the user moves the stylus 30 across the surface of the display 24 (again without necessarily touching the surface of the display 24), the electronic device 30 alters the position of the cursor 38 (as shown in phantom) to reflect such movement. Again, therefore, the electronic device 20 enables a user to identify more easily the position of the stylus 30 relative to the display 24 prior to making an actual selection.

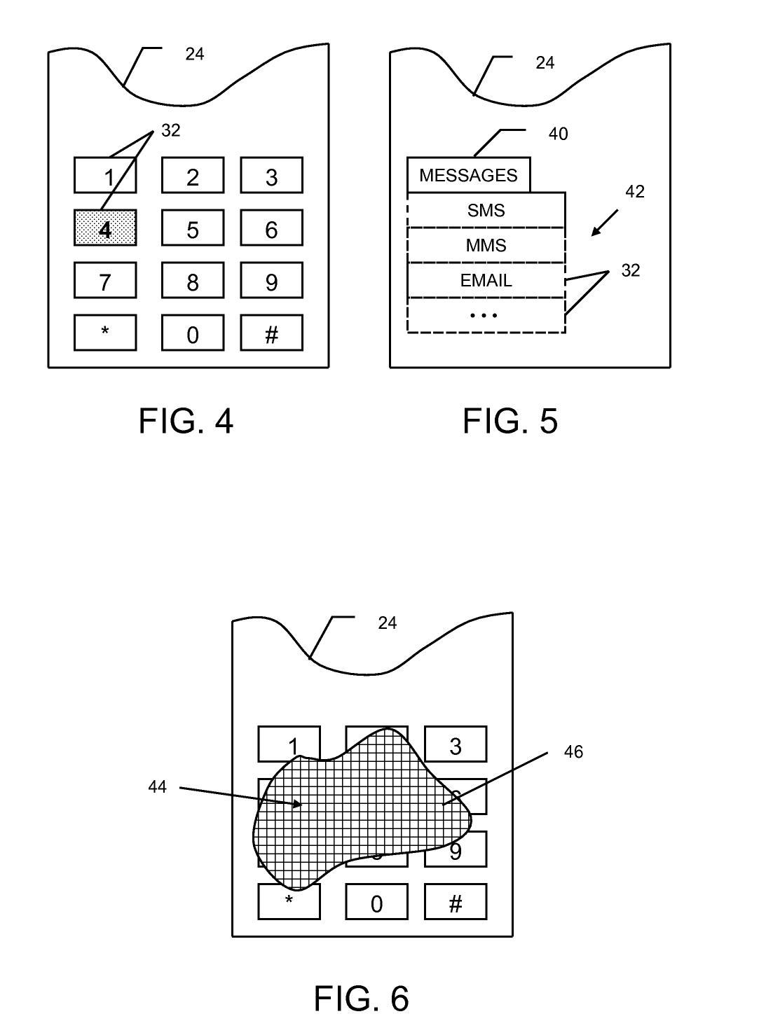

FIG. 4 shows an example where the electronic device 20 highlights the icon 32 associated with the determined location of the stylus 30, e.g., numeric key “4”, by changing the visual characteristics of the icon. For example, the color, shading, brightness, etc., of the icon 32 can be changed. Such changes may be made in addition to or instead of changes in size, cursor location, etc. associated with the determined location of the stylus 30 as discussed above in relation to FIGS. 2 and 3.

FIG. 5 represents an example of the present invention in relation to the use of drop down menus. When the electronic device 20 determines that the position of the stylus 30 corresponds to that of a menu tab 40 (e.g., “Messages”), again without the stylus 30 necessarily touching the surface of the display 24, the electronic device 20 causes the corresponding menu 42 to drop down. The user may then proceed to select a desired icon 32 within the menu 42 using the same principles described above.

FIG. 6 shows the display 24 in partial cutaway in order to show an array 44 of sensors 46 for determining the location of the stylus 30. The sensors 46 may be arranged in rows and columns analogous to an array of pixels making up the display 24. The sensors 46 may correspond one-to-one with the pixels in the display 24, or may be provided at some other ratio depending on the desired resolution of the location determination section of the electronic device. The sensors 46 may be manufactured as part of each pixel in the display. Alternatively, the array 44 may be formed of a separate layer as will be appreciated.

According to one particular example of the invention, each of the sensors 46 comprises an inductive type sensor such as a Hall-effect element. The sensors 46 are configured to sense a change in magnetic field resulting from the presence of the stylus 30 proximate the surface of the display 24. In accordance with another particular example, each of the sensors 46 is an electro-optic type sensor. As described in more detail below, the stylus 30 may project a light beam onto the display 24. The sensors 46 in turn detect the light beam enabling the electronic device 20 to determine the location of the stylus 30 relative to the display 24 without the stylus necessarily touching the surface of the display 24.

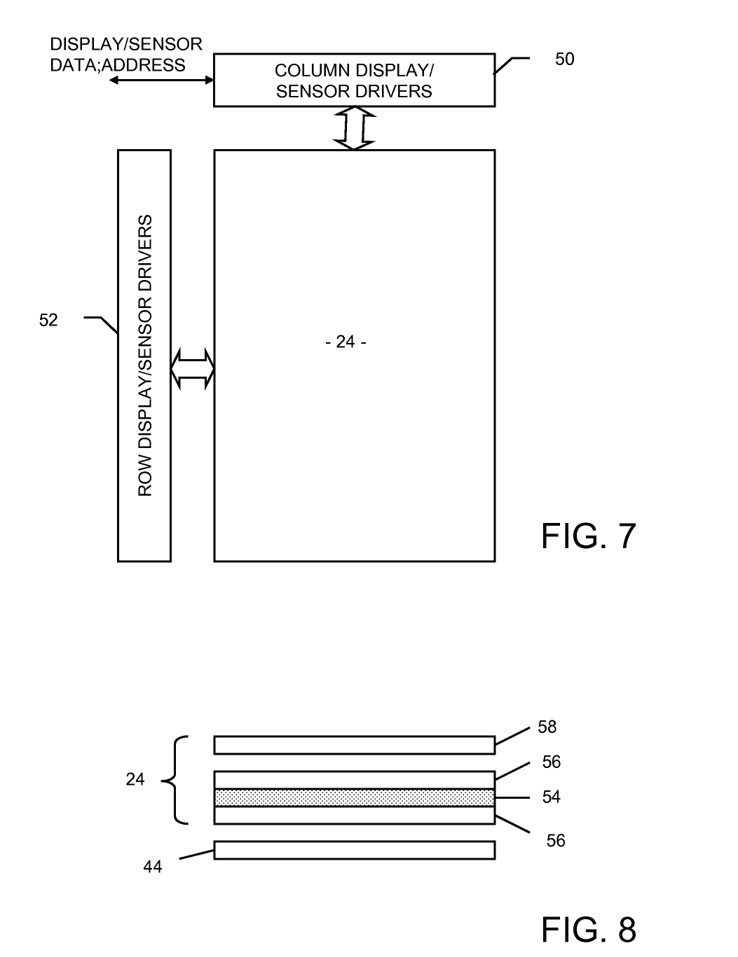

FIGS. 7 and 8 illustrates an exemplary structure and drive circuitry for the display 24 in accordance with the present invention. As shown in FIG. 7, the column display/sensor drivers 50 and row display/sensor drivers 52 drive the display 24. The column and row drivers 50 and 52 display data on the display 24 according to conventional techniques. In addition, the column and row drivers 50 and 52 are configured to read out the sensor data from each of the sensors 46 within the array 44. This sensor data is in turn provided to the location determining function within the electronic device 20 for subsequent processing. More specifically, by identifying which particular sensor(s) in the sensor array 44 detect the greatest change in magnetic field influence, the highest magnitude light detection, etc., the electronic device 20 determines the particular location of the stylus 30 relative to the display 24.

Referring to FIG. 8, the display 24 in the exemplary embodiment is made up primarily of a liquid crystal layer 54 sandwiched between glass substrates 56. The touch sensitive screen 58 is formed at the top of the display 24. The sensor array 44, in the exemplary embodiment, is formed below the display 24. In the case where the sensor array 44 is made up of electro-optic type sensors 46, the various layers of the display 24 are preferably largely transmissive with respect to wavelengths of light corresponding to the light beam emitted by the stylus 30. In another embodiment, the sensor array 44 may be placed above the display 24. In such case, the sensors 46 are preferably optically transparent as will be appreciated.

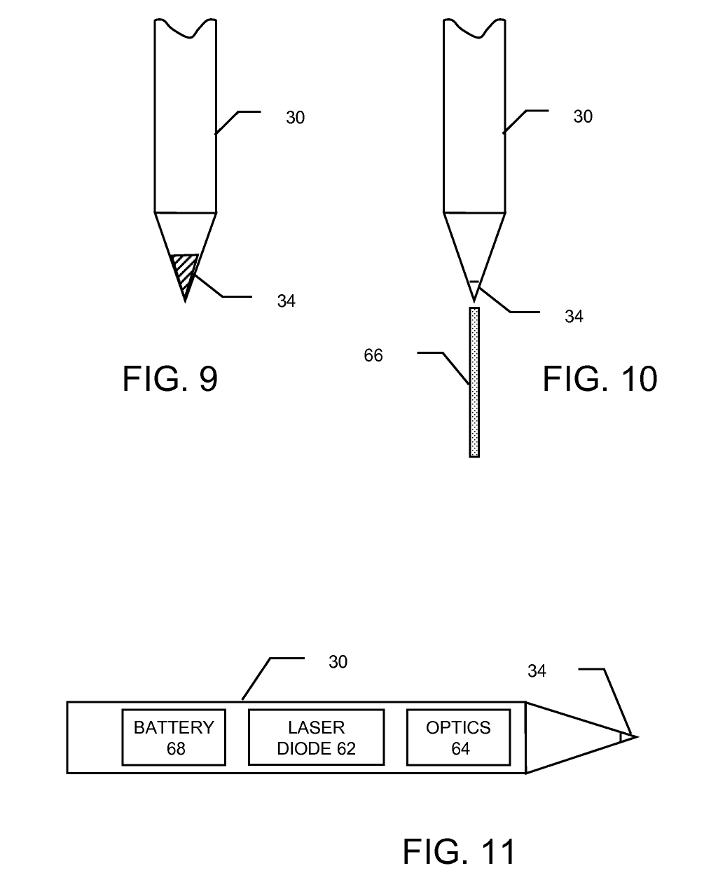

FIG. 9 shows an example of the stylus 30 for use in an embodiment in which the sensor array 44 is made up of inductive type sensors 46. Specifically, the tip of the stylus 34 is made of a ferromagnetic material such as iron or the like. The sensors 46 are particularly responsive to the ferromagnetic tip 34, thereby increasing the sensitivity of the sensor array 44.

FIGS. 10 and 11 show an example of the stylus 30 for use in an embodiment in which the sensor array 44 includes an array of electro-optic sensors 46. Included within the body of the stylus 30 is a laser light source such as a laser diode 62. The stylus 30 further includes laser optics 64 that, in combination with the laser diode 62, produce a laser light beam 66 emitted from the tip 34 of the stylus 30. A battery 68 provides operating power to the laser diode 62. Thus, as a user moves the stylus 30 above the surface of the display 24 the laser light beam 66 will be detected by the sensor array 44, thereby determining the position of the stylus 30.

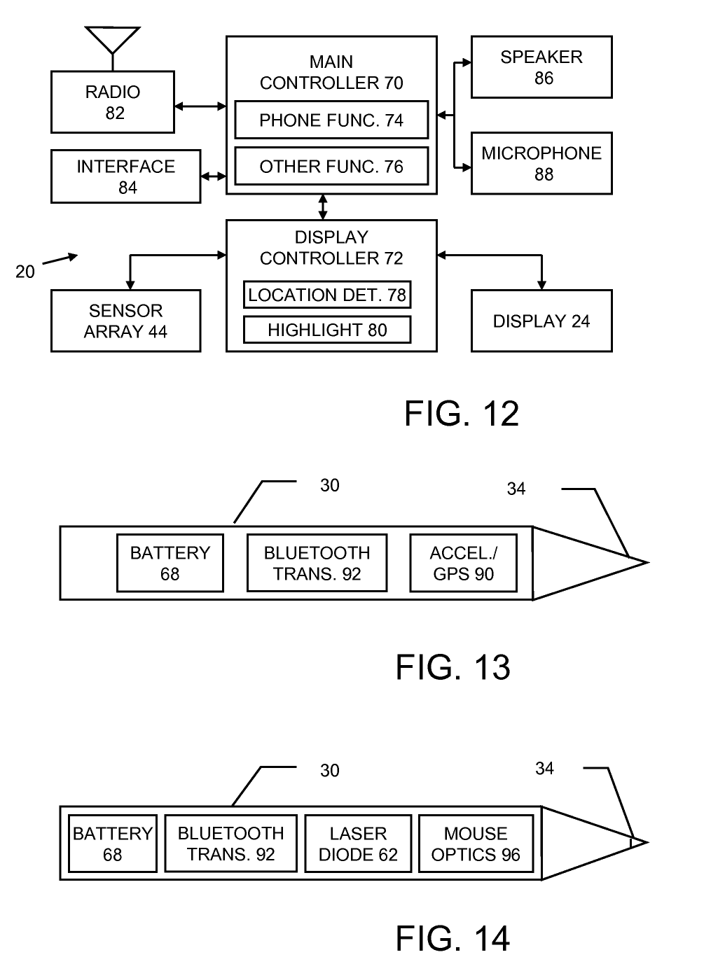

Referring to FIG. 12, the electronic device 20 according to the exemplary embodiment includes a main controller 70 and display controller 72. The main controller 70 is configured to carry out conventional mobile phone functions 74 and other functions (e.g., data organizer, media player, pocket computing, etc.). The display controller 72 is configured to carry out conventional touch screen display control in relation to the display 24. In addition, however, the display controller 72 is configured to determine the location of the stylus 30 and to provide highlights on the display 24 in accordance with the invention via a location determination function 78 and highlight function 80. As will be appreciated, the main controller 70 and display controller 72 may be made up of any combination of hardware, software, firmware, etc., without departing from the scope of the invention.

The electronic device 20 further includes a radio transceiver 82 enabling wireless communications with a wide-area network (WAN) such as that provided by a mobile communications service provider network. Additionally, the electronic device 20 may include an interface 84 for communicating with other devices, peripherals, etc. The interface 84 may include a connector for providing a hardwired connection between the electronic device 20 and other devices, etc. In addition, or in the alternative, the interface 84 may provide a wireless connection between the electronic device 20 and other devices. For example, the interface 84 may include a Bluetooth transceiver, infrared port, or the like that enables data communication using known protocols.

Also included in the electronic device 20 are various other components commonly found, such as a speaker 86 and microphone 88 in the case where the electronic device is a mobile phone.

During operation in accordance with the invention, the sensor array 44 provides sensor data to the display controller 80. As described previously in relation to FIG. 7, data from the respective sensors 46 is obtained via the column and row drivers 50 and 52. The data is provided to the location determination function 78 within the display controller 72. The location determination function 78 processes the data by analyzing, for example, the position on the display 24 of the particular sensor or sensors 46 producing the greatest amplitude, change in amplitude, etc. As will be appreciated, the sensor or sensors 46 to which the stylus tip 34 is most proximate will have an output that stands out among the respective outputs of the other sensors included in the array 44. Based on the position of such sensor or sensors 46, the location determination function 78 determines the precise location of the stylus 30 relative to the display 24.

The location determination function 78 provides such location information to the highlight function 80 within the display controller 72. The highlight function 80 in turn provides appropriate highlighting in accordance with the location of the stylus 30. For example, if the location of the stylus 30 is determined to be coincident with a given icon 32 the highlight function 80 causes the icon 32 to become magnified (FIG. 2) and/or to change in color, shading, etc. on the display 24 (FIG. 4). In addition, or in the alternative, the highlight function 80 highlights on the display 24 the path of the stylus 30 as it moves across the display 24, e.g., via a cursor 38 as in FIG. 3. Again, however, the determining of the location of the stylus 30 and the highlighting on the display 24 is provided without necessitating that the stylus 30 actually contact the surface of the display 24.

FIG. 13 illustrates another embodiment of the stylus 30. In this embodiment, the stylus 30 includes an accelerometer and/or GPS receiver 90. In addition, the stylus 30 includes a Bluetooth transceiver 92 or other wireless interface. Such a configuration allows the stylus 30 in conjunction with the electronic device 20, to determine the position of the stylus 30 without the need for the sensor array 44. For example, in the case where the stylus 30 includes an accelerometer 90 at the tip 34, the position of the stylus tip 34 may be determined by integrating the output of the accelerometer 90. The user first initializes use of the stylus 30 with the device 20 by contacting the display 24 at a reference location such as a reference contact spot 94 as shown in FIG. 1. The electronic device 20 is configured to detect when such contact spot 94 is pressed with the stylus 30, thus providing the electronic device 20 with a known relative location of the stylus.

Thereafter, as the user moves the stylus 30 across the display 24 the accelerometer 90 will produce data indicative of the movement of the stylus 30. The stylus 30 transmits the accelerometer data to the electronic device 20 via the Bluetooth transceiver 92. The electronic device 20 in turn receives the accelerometer data via its corresponding interface 84. The electronic device 20 in turn processes the accelerometer data in order to ascertain the specific movement of the stylus 30 relative to the display 24, and specifically relative to the contact spot 94. The location determination function 78 is thus able to identify the particular location of the stylus 30 relative to the display 24 and provide such information to the highlight function 80.

In the case where the stylus 30 includes a GPS transceiver 90 at the tip 34, the stylus 30 provides location data of the tip 34 to the electronic device 20 via the Bluetooth transceiver 92 and corresponding interface 84. For example, the user may initialize use of the stylus 30 by contacting the display 24 at the reference contact spot 94. The electronic device 20 registers when such contact spot 94 is pressed with the stylus 30, thus again providing the electronic device 20 with a known relative location of the stylus 30. Then, as the user moves the stylus 30 across the display 24 the stylus 30 transmits the GPS location data to the electronic device 20. The GPS data is provided to the location determination function 78 and thus provides the relative location of the stylus 30. As in the other embodiments described herein, the highlight function 80 proceeds to provide corresponding highlighting on the display 24.

In the above examples relating to the embodiment of FIG. 13, it is assumed that the electronic device 20 remains stationary as the stylus 30 is moved about the display 24. In another embodiment, however, the electronic device 20 may include its own accelerometer and/or GPS receiver to provide location information of the electronic device 20 itself. Thus, if the user moves the electronic device 20 itself (e.g., while walking, driving, etc.), the location of the stylus 30 relative to the display 24 still may be accurately ascertained by comparing movement of the stylus 30 with the movement of the electronic device 20.

FIG. 14 shows an embodiment of the stylus 30 that utilizes laser technology commonly found in optical mouse devices. Specifically, the stylus 30 includes a laser diode 62 in combination with “mouse” optics 96. The optics 96 are configured to image light from the laser diode 62 onto the surface of the display 24, and to direct the laser light reflected off the display 24 back onto an image sensor (not shown) included within the stylus 30. The output of the image sensor is indicative of the movement of the stylus 30, and such output is provided to the electronic device 20 via the Bluetooth transceiver 92 and the interface 84. Preferably, the optics 96 are optimized for the case where the tip 34 of the stylus 30 is maintained above the surface of the display 24, again further avoiding the need for the stylus 30 to contact the surface of the display 24. As in the previous embodiment of FIG. 13, the user may initialize the position of the stylus 30 relative to the display 24 by contacting the contact spot 94.

Like the embodiment of FIG. 13, the embodiment of FIG. 14 is capable of functioning without the sensor array 44.

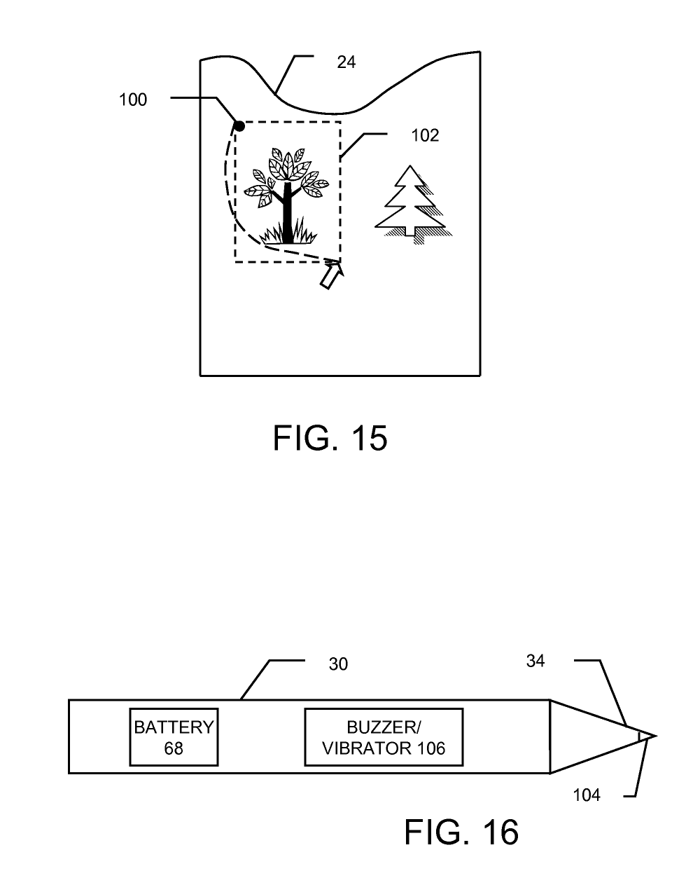

FIG. 15 illustrates operation of the invention particularly suited for “cut-and-paste” or “drag-and-drop” type functions. In this embodiment, the position of the stylus 30 is initialized by the user making contact with the stylus 30 on the surface of the display 24. For example, the user contacts the stylus 30 on the display 24 at an initiation point 100. By way of the touch sensitive screen, the electronic device 20 registers the position of the stylus 30. Thereafter, the user may lift the stylus 30 from the surface of the display 24 and proceed to move the stylus 30 across the surface of the display without contacting the surface. In accordance with any of the embodiments described above, the location determination function 78 determines the location of the stylus 30 relative to the initiation point 100. The location determination function 78 provides such information to the highlight function 80 that in turn highlights such movement on the display 24.

For example, in a cut-and-paste operation the highlight function 80 causes a rectangular box 102 to appear on the display 24 in relation to the movement of the stylus 30. Opposite corners of the box 102 are based on the initiation point 100 and the current position of the stylus 30 similar to conventional cut-and-paste operations. The user may then select the contents of the thus created box 102 by bringing the stylus 30 back into contact with the surface of the display 24, for example.

In the case of a drag-and-drop operation, the initiation point 100 corresponds to the location of an icon, etc. on the display. By contacting the surface of the display 24 with the stylus 30 at the initiation point 100, the stylus 30 effectively “picks up” the icon or the like. The user then lifts the stylus 30 from the surface of the display 24 and proceeds to move the stylus 30 across the display 24. The location determination function 78 provides location information to the highlight function 80 that in turn causes the icon to be “carried” or “dragged” across the display 24 in accordance with the movement of the stylus 30. The icon may then be effectively “dropped” at the current location of the stylus by bringing the stylus 30 back into contact with the surface of the display 24, for example.

FIG. 16 illustrates a feature of the invention that may be included in any of the different embodiments of styluses described above. According to this feature, the stylus 30 provides audible and/or tactile feedback to the user indicating when the stylus 30 is in contact with the display surface 24 versus not in contact. Specifically, the stylus 30 includes a microswitch 104 or the like at the tip 34. In addition, the stylus 30 includes a feedback mechanism 106 such as a small buzzer, vibrator, beeper, etc. The feedback mechanism 106 is coupled to the microswitch 104 such that if the tip 34 of the stylus 30 makes contact with the surface of the display 24, the feedback mechanism 106 produces a brief buzzer sound, beeper sound, vibration, or the like. In this manner, the user knows that the stylus 30 has made contact with the surface of the display 24. Depending on whether the user intended to make contact or not, the user may proceed accordingly.

In view of the above, it will be appreciated that the display and stylus of the present invention better enable a user to utilize the display without erroneous data entry, unintended selection, frustration, etc.

The term “electronic device” as referred to herein includes portable radio communication equipment. The term “portable radio communication equipment”, also referred to herein as a “mobile radio terminal”, includes all equipment such as mobile phones, pagers, communicators, e.g., electronic organizers, personal digital assistants (PDAs), smartphones or the like.

Although the invention has been shown and described with respect to certain preferred embodiments, it is obvious that equivalents and modifications will occur to others skilled in the art upon the reading and understanding of the specification. The present invention includes all such equivalents and modifications, and is limited only by the scope of the following claims.

1. An electronic device, comprising:
a display for displaying icons selectable with use of a stylus;
a stylus location determination function that determines a location of the stylus in relation to the display without necessitating that the stylus make physical contact with the display; and
a highlight function, operatively coupled to the stylus location determination function, that highlights the icon associated with the location of the stylus prior to the stylus making physical contact with the display.

2. The electronic device of claim 1, wherein the display is a touch sensitive display screen.

3. The electronic device of claim 1, wherein the highlight function magnifies the icon being highlighted.

4. The electronic device of claim 1, wherein the highlight function comprises a cursor presented on the display directed to the icon being highlighted.

5. The electronic device of claim 1, wherein the highlight function alters a visual characteristic of the icon being highlighted.

6. The electronic device of claim 1, wherein the stylus location determination function comprises an array of inductive sensors for sensing changes in a magnetic field resulting from the stylus.

7. The electronic device of claim 6, in combination with the stylus, wherein the stylus comprises a tip including ferromagnetic material.

8. The electronic device of claim 1, wherein the stylus location determination function comprises an array of optical sensors for sensing optical radiation emitted by the stylus.

9. The electronic device of claim 8, in combination with the stylus, wherein the stylus comprises an optical radiation light source.

10. The electronic device of claim 1, comprising an input for receiving information from the stylus indicative of the position of the stylus relative to the display, and wherein the stylus location determination function determines which icon displayed on the display is associated with the location of the stylus prior based on the received information.

11. The electronic device of claim 10, in combination with the stylus, wherein the information received from the stylus is based on an accelerometer included within the stylus.

12. The electronic device of claim 10, in combination with the stylus, wherein the information received from the stylus is based on an optical device included in the stylus for detecting a path traveled by a light beam along the surface of the display.

13. The electronic device of claim 10, in combination with the stylus, wherein the stylus includes circuitry for providing audible and/or tactile feedback to a user when the stylus contacts the surface of the display.

14. An electronic device, comprising:
a display;
a stylus location determination function that determines a location of a stylus relative to the display as the stylus moves across the display, without the stylus necessarily making physical contact with the display; and
a highlight function, operatively coupled to the stylus location determination function, that highlights on the display the movement of the stylus determined by the stylus location determination function.

15. The electronic device of claim 14, wherein the display is a touch sensitive display screen.

16. The electronic device of claim 15, where the stylus location determination function determines the movement of the stylus subsequent to the stylus touching the touch sensitive display, and the highlight function highlights on the display the movement of the stylus relative to the point at which the stylus touched the touch sensitive display.

17. The electronic device of claim 16, wherein the highlight function highlights the movement by creating a rectangle on the display that includes in one corner the point at which the stylus touched the display, and includes in an opposite corner the current location of the stylus relative to the display.

18. The electronic device of claim 14, wherein the stylus location determination function comprises an array of at least one of inductive sensors for sensing changes in a magnetic field resulting from the stylus, or optical sensors for sensing optical radiation emitted by the stylus.

19. The electronic device of claim 14, comprising an input for receiving information from the stylus indicative of the position of the stylus relative to the display, and wherein the stylus location determination function determines the movement of the stylus based on the received information.

20. The electronic device of claim 19, in combination with the stylus, wherein the information received from the stylus is based on at least one of an accelerometer, global positioning system, or optical device included within the stylus.
